(19) United States
(12) Patent Application Publication
(10) Pub. No.: US 2003/0087603 A1
(43) Pub. Date: May 8, 2003

(54) Framing method and the synchronous wireless system therewith

(75) Inventors: Daoben Li, Beijing (CN); Haiyang Gao, San Jose, CA (US); Shiu Ming Joseph Ho, San Jose, CA (US); Yongsheng Zhang, Beijing (CN); Weidong Chen, San Jose, CA (US); Yuanhua Deng, San Jose, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Linkair Communications, Inc.

(21) Appl. No.: 10/308,514

(22) Filed: Dec. 3, 2002

Related U.S. Application Data
(63) Continuation of application No. PCT/CN00/00137, filed on Jun. 5, 2000.

(51) Int. Cl. H04B 1/10; H04B 15/00; H04B 7/005; H04B 7/01; H04B 7/015

(52) U.S. Cl. 455/63; 455/502

(57) ABSTRACT

A framing method and the synchronous wireless system therewith, wherein the method includes the steps of: partitioning the data stream into frames according to the frame length, in which the number of sub-frame in each frame can be determined by the periodicity of selected LA codes; forming each sub-frame by a plurality of time slots, in which the number of the said time slots can be determined by the number of pulses of the said LA codes, and the said time slot length varies with the variation of the pulse interval of the said LA codes; and filling in each time slot by modulation with the selected orthogonal spread spectrum codes. Different base stations from different, nearby cells shall be assigned different LA-CDMA codes so that adjacent cell interference can be reduced. While in nearby cells, the same spreading code can be assigned, therefore greatly reducing requirement for the number of spreading codes, as well as the requirement for the lengths of the spreading codes.

### CROSS-REFERENCE TO RELATED APPLICATIONS

This is a continuation application of PCT/CN00/00137, filed Jun. 5, 2000, which is incorporated herein by reference in its entirety.

### BACKGROUND OF THE INVENTION

1. Field of the Invention

The present invention relates generally to a framing method and wireless system therewith, particularly to a framing method for physical layer and the synchronous wireless system therewith, and more particularly, to a system and method that reduces interferences and combines code division multiple access (“CDMA”) with time division multiple access (“TDMA”).

2. Description of Related Art

In a CDMA system, each remote unit modulates the data that it sends to a base station by a spreading code that is unique to the remote unit. The spread spectrum, coded signals transmitted by different remote units may overlap in both time and frequency. When these signals arrive at the receiving base station, the data sent by a remote unit are obtained by correlating the received signal with the unique spreading code of the remote unit.

It is well known that the capacity of a CDMA system is limited by the interferences. The interferences include Inter-Symbol Interference (“ISI”) among multipath signals from a same remote unit, Multiple Access Interferences (“MAI”) among signals from different remotes units in the service area of a same base station, and Adjacent Cell Interference (“ACI”) among signals from neighboring base stations and the remote units that they serve. In prior art, to reduce the adjacent cell interference, different base stations in different, nearby cells have to use different spreading codes at a certain time. Thus the code length of spreading codes has to be very long to provide enough spreading codes. This greatly increases the complexity of the system.

Existing CDMA systems use pseudo-random spreading codes that result in non-zero interferences. Even when orthogonal spreading codes such as Walsh codes are used that give zero interference, the orthogonal property can be destroyed when there are multipath signals from a same remote unit or the signals from different remote units are not synchronized, resulting in interferences among different signals.

In PCT application PCT/CN98/00151, invented by Li Daoben and entitled “A Spread Spectrum Multiple Access Coding Method,” a coding scheme called Large Area code (“LA code”) was disclosed, wherein a spread spectrum access code consists of basic pulses that have normalized amplitude and duration of 1 and polarity, the number of basic pulses is ascertained by such practical factors: the requested number of users, the number of usable pulse compression codes, the number of usable orthogonal carrier frequencies, system bandwidth and system maximal information rate. The intervals between these basic pulses on time axis are various, and coding just utilizes the dissimilarity of pulse positions and orders of pulses' polarities. Hereinafter such codes will be called LA codes or LA-CDMA codes, which have the same meaning.

Table 1 shows a primary LA-CDMA code with 16 pulses with its corresponding sequence of 16 time slots with different lengths.

TABLE 1
Primary LA-CDMA code

| | | | | | | | | | | | | | | | | |
|---|---|---|---|---|---|---|---|---|---|---|---|---|---|---|---|---|
| Time | 1 | 2 | 3 | 4 | 5 | 6 | 7 | 8 | 9 | 10 | 11 | 12 | 13 | 14 | 15 | 16 |
| Slot | | | | | | | | | | | | | | | | |
| Length | 138 | 140 | 142 | 144 | 146 | 148 | 150 | 152 | 154 | 156 | 158 | 160 | 162 | 164 | 172 | 137 |
| Of TS | | | | | | | | | | | | | | | | |

When relaxing the restriction of orthogonality, (i.e. to adopt quasi-orthogonality which uses imperfect orthogonal codes), the number of users may be increased. For example, considering an LA code with N pulses, as the order of N basic intervals has no affect on its auto-correlation and cross-correlation functions, it can be arbitrary. When a code group with various orders of basic intervals is exploited at the same time, the number of users will increase enormously.

Table 2 shows 16 LA-CDMA codes that are obtained by permuting the time slots in the primary LA-CDMA code.

TABLE 2
List of LA-CDMA Codes

| LA | | | | | | | | | | | | | | | | |
|---|---|---|---|---|---|---|---|---|---|---|---|---|---|---|---|---|
| Code | Time Slot Sequence of LA Codes | | | | | | | | | | | | | | | |
| 0 | 1 | 2 | 3 | 4 | 5 | 6 | 7 | 8 | 9 | 10 | 11 | 12 | 13 | 14 | 15 | 16 |
| 1 | 2 | 4 | 6 | 8 | 10 | 12 | 14 | 16 | 1 | 3 | 5 | 7 | 9 | 11 | 13 | 15 |
| 2 | 3 | 6 | 9 | 12 | 15 | 1 | 4 | 7 | 10 | 13 | 16 | 2 | 5 | 8 | 11 | 14 |
| 3 | 4 | 8 | 12 | 16 | 3 | 7 | 11 | 15 | 2 | 6 | 10 | 14 | 1 | 5 | 9 | 13 |
| 4 | 5 | 10 | 15 | 3 | 8 | 13 | 1 | 6 | 11 | 16 | 4 | 9 | 14 | 2 | 7 | 12 |
| 5 | 6 | 12 | 1 | 7 | 13 | 2 | 8 | 14 | 3 | 9 | 15 | 4 | 10 | 16 | 5 | 11 |
| 6 | 7 | 14 | 4 | 11 | 1 | 8 | 15 | 5 | 12 | 2 | 9 | 16 | 6 | 13 | 3 | 10 |
| 7 | 8 | 16 | 7 | 15 | 6 | 14 | 5 | 13 | 4 | 12 | 3 | 11 | 2 | 10 | 1 | 9 |
| 8 | 9 | 1 | 10 | 2 | 11 | 3 | 12 | 4 | 13 | 5 | 14 | 6 | 15 | 7 | 16 | 8 |
| 9 | 10 | 3 | 13 | 6 | 16 | 9 | 2 | 12 | 5 | 15 | 8 | 1 | 11 | 4 | 14 | 7 |
| 10 | 11 | 5 | 16 | 10 | 4 | 15 | 9 | 3 | 14 | 8 | 2 | 13 | 7 | 1 | 12 | 6 |
| 11 | 12 | 7 | 2 | 14 | 9 | 4 | 16 | 11 | 6 | 1 | 13 | 8 | 3 | 15 | 10 | 5 |
| 12 | 13 | 9 | 5 | 1 | 14 | 10 | 6 | 2 | 15 | 11 | 7 | 3 | 16 | 12 | 8 | 4 |
| 13 | 14 | 11 | 8 | 5 | 2 | 16 | 13 | 10 | 7 | 4 | 1 | 15 | 12 | 9 | 6 | 3 |
| 14 | 15 | 13 | 11 | 9 | 7 | 5 | 3 | 1 | 16 | 14 | 12 | 10 | 8 | 6 | 4 | 2 |
| 15 | 16 | 15 | 14 | 13 | 12 | 11 | 10 | 9 | 8 | 7 | 6 | 5 | 4 | 3 | 2 | 1 |

The orthogonal characteristic or quasi-orthogonality of the LA codes can serve as a solution for reducing interference of adjacent service areas or channels.

### SUMMARY OF THE INVENTION

An object of the present invention is a framing method for a physical layer and a wireless system therewith, which can provide a high capacity and high performance communications system using spread spectrum modulation.

Another object of the present invention is a framing method for a physical layer and a wireless system therewith, which uses orthogonal codes that have a zero-correlation window.

According to the present invention, as embodied and broadly described herein, a framing method and a system are provided for spread spectrum communications. Preferably, the said system comprises a plurality of cells organized in a cellular environment, one base station in each cell transmitting downlink signals to remote units within the cell, and a plurality of remote units in each cell transmitting uplink signals. Both code division multiple access and time division multiple access are provided on both/either the downlink from a base station to remote units and the uplink from remote units to a base station.

Another aspect of the present invention is a framing method for physical layer of a wireless system, wherein the method includes the steps of: partitioning the data stream into frames according to the frame length, in which the number of sub-frame in each frame can be determined by the periodicity of selected LA codes; forming each sub-frame by a plurality of time slots, in which the number of the said time slots can be determined by the number of pulses of the said LA codes, and the said time slot length varies with the variation of the pulse interval of the said LA codes; and filling in each time slot by modulation with the selected orthogonal spread spectrum codes.

Another aspect of the present invention is the framing method previously described, wherein the permutation position of the said LA codes can be recombined, and the permutation of the said time slot can be also recombined corresponding to it.

Yet another aspect of the present invention is a synchronous wireless system established according to the above said framing method, which is composed of base station and mobile station, wherein the base station and mobile station use the said LA codes and LS codes, and different base stations use different LA codes and LS codes; different subscribers can be distinguished by means of CDMA and/or TDMA mode according to the above said framing method or frame structure.

In an aspect of the present invention, different base stations from different, nearby cells shall be assigned different LA-CDMA codes so that adjacent cell interference can be reduced. While in nearby cells, the same spreading code can be assigned, therefore greatly reducing the requirement for the number of spreading codes, as well as the requirement for the lengths of the spreading codes.

### BRIEF DESCRIPTION OF THE ATTACHED DRAWINGS

The accompanying drawings which are incorporated in and constitute a part of this specification, illustrate particular embodiments of the invention, and together with the description, serve to explain, and not restrict, the principles of the invention.

FIG. 1 illustrates an exemplary cellular system with multiple cells.

FIG. 2 illustrates an exemplary base station and a plurality of remote units in one cell.

FIG. 3 illustrates an exemplary 20 ms frame structure of the downlink from a base station to a plurality of remote units with a chip rate of 1.2288 MHz, and the 20 ms frame structure of the uplink from remote units to a base station with a chip rate of 1.2288 MHz, in an embodiment of the present invention.

FIG. 4 illustrates an exemplary structure of a sub-frame and the structure of a time slot in an embodiment of the present invention.

FIG. 5 illustrates an exemplary structure of a Forward Sync Channel on a downlink in an embodiment of the present invention.

FIG. 6 illustrates an exemplary structure of a Reverse Sync Channel on an uplink in an embodiment of the present invention.

FIG. 7 illustrates the exemplary arrival times of signals from four different remote units that are normalized to the beginning of a 20 ms frame in an embodiment of the present invention.

FIG. 8 illustrates exemplary time slot allocations per LS code for a pilot channel in an embodiment of the present invention.

FIG. 9 illustrates exemplary time slot allocations per LS code for a power control channel in an embodiment of the present invention.

FIG. 10 illustrates exemplary sub-frame allocation per LS code for a fundamental channel in an embodiment of the present invention.

FIG. 11 illustrates an exemplary state diagram of an enhanced 16QAM modulation in an embodiment of the present invention.

### DETAILED DESCRIPTION OF THE INVENTION

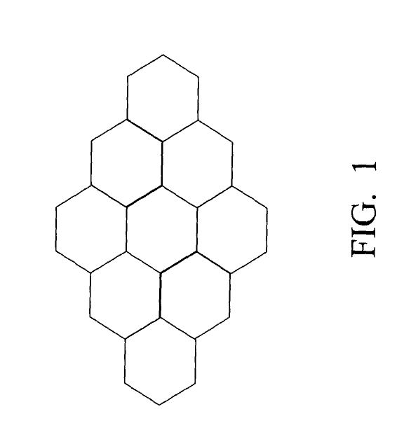

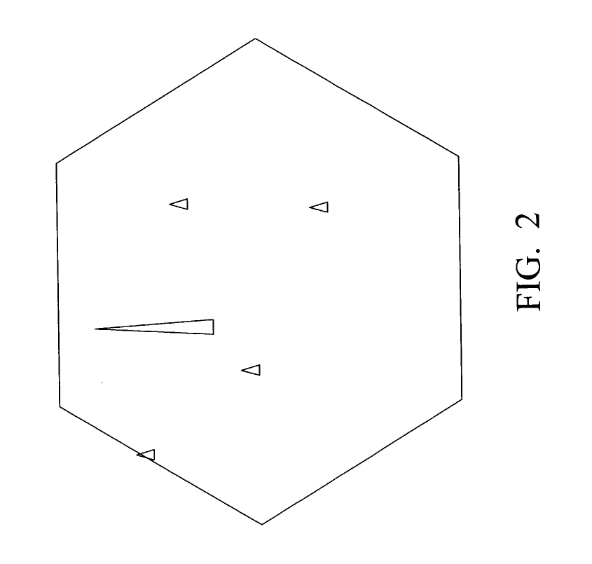

A preferred embodiment of a communications system of the present invention, as shown in FIG. 1, includes a cellular system comprising multiple cells that serve a geographic area, a base station in each cell providing a downlink signal to remote units in the cell, and a plurality of remote units in each cell. FIG. 2 shows a base station and a plurality of remote units in a cell. The base station includes transmitters and receivers and appropriate processors for implementing the methods of the present invention. Each of the plurality of remote units includes a transmitter, a receiver, and an appropriate processor for implementing the methods of the present invention.

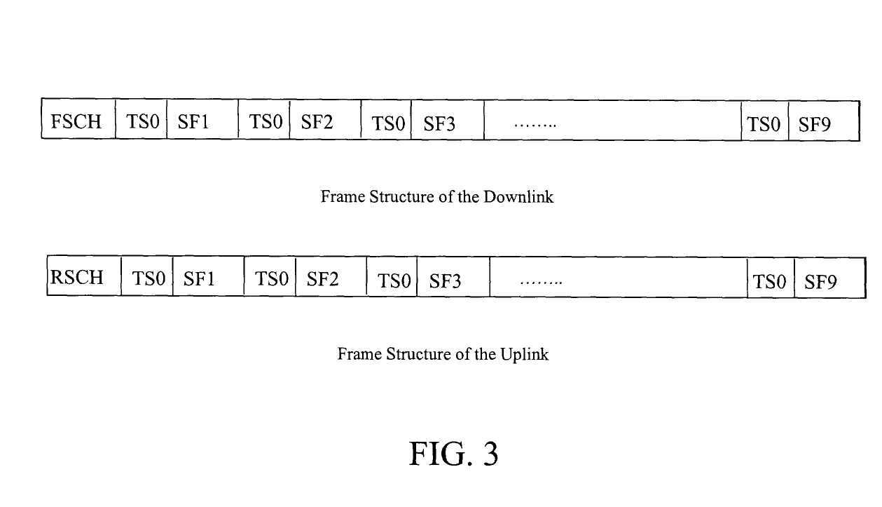

In a preferred embodiment, the present invention can use the frequency band of the Advanced Mobile Phone System (“AMPS”) or the Personal Communications Systems (“PCS”) band with frequency division duplex (“FDD”). As a preferred embodiment of the present invention, FIG. 3 illustrates the 20 ms frame structure of the downlink with a chip rate of 1.2288 MHz, and the 20 ms frame structure of the uplink with a chip rate of 1.2288 MHz. The same principles and methods can be applied to different chip rates, such as multiples of 1.2288 MHz.

In FIG. 3, the 20 ms frame on the downlink consists of a Forward Sync Channel (“FSCH”) that is 1545 chips in length, followed by nine time slot (“TS0”)—sub-frame (“SF1, SF2, . . . , SF9”) pairs. Each time slot (“TS0”) is 136 chips in length and each sub-frame is 2,423 chips in length. The Forward Sync Channel is used by a base station to provide synchronization and system information to remote units. The time slots (“TS0”) and the sub-frames (“SF1, SF2, . . . , SF9”) are used to provide control and traffic channels from a base station to remote units. These time slots and sub-frames provide time division multiple access since different control and traffic channels can be transmitted at different times.

The 20 ms frame on the uplink from remote units to a base station consists of a Reverse Sync Channel (“RSCH”) that is 1545 chips in length, followed by nine time slot (“TS0”)—sub-frame (“SF1, SF2, . . . , SF9”) pairs. The Reverse Sync Channel is used by remote units to establish reverse synchronization with a base station. The time slots and sub-frames are used to provide control and traffic channels from remote units to a base station. These time slots and sub-frames provide time division multiple access since different control and traffic channels can be transmitted at different times. The separation of the Reverse Sync Channel from the sub-frames in the time dimension minimizes the interference between the random access during reverse synchronization of remote units with a base station and transmission of control and traffic from remote units to a base station.

In slightly different but equivalent terminology, each time slot (“TS0”)—sub-frame (with 16 time slots) pair can be considered a sub-frame with 17 time slots and with TS0 always at the front of the sub-frame. Such a change in terminology does not change the content of the frame structure on the downlink or the uplink. The present invention separates TS0 from a sub-frame in its terminology.

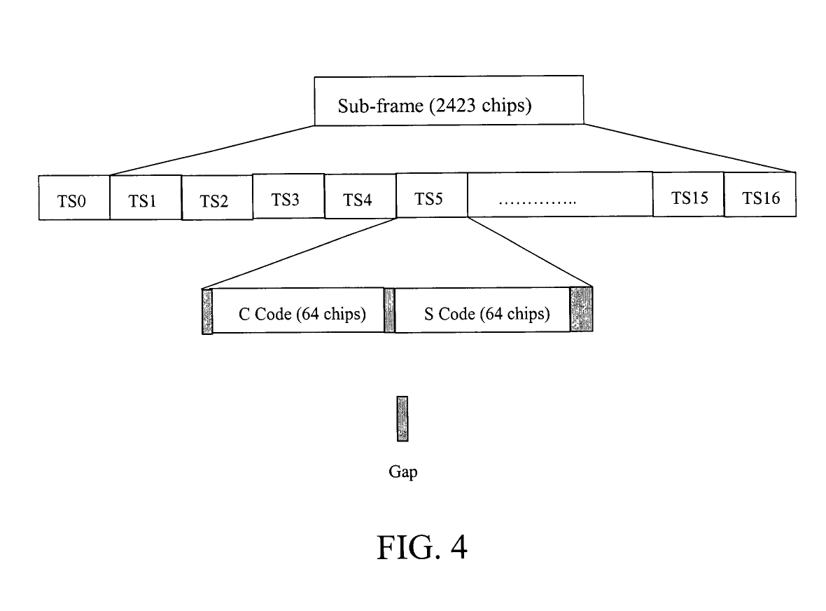

The structure of a sub-frame on the uplink can be the same as that on the downlink. FIG. 4 illustrates the structure of a sub-frame, comprising 2423 chips divided into 16 time slots (“TS1 , TS2, . . . , TS16”) of different lengths. Each sub-frame is filled with one LA-CDMA code of length 2423 chips, which determines the lengths of time slots in the sub-frame.

Different base stations from different, nearby cells shall be assigned different LA-CDMA codes to reduce the adjacent cell interference.

The pulse polarity of the said LA codes can be transformed, and the polarity of the said time slot can be also transformed to correspond to it.

PCT Application with inventor, number and title of it respectively as Li Daoben, PCT-CN00/00028 and “A Scheme for Spread Spectrum Multiple Address Coding with Interference Free Window,” disclosed a kind of complementary orthogonal codes referred to here as LS codes. The LS codes have an “Interference Free Window” property, which is also referred to as “zero correlation window” property. As an illustration, consider the following four LS codes of length 8:

(C1, S1)=(++−+, +−−−)

(C2, S2)=(+++−, +−++)

(C3, S3)=(−+++, −−+−)

(C4, S4)=(−+−−, −−−+)

The cross-correlation of any two of these codes is zero when the time shift between the two codes is within the (inclusive) window [−1, +1], and the auto-correlation of any of these codes is zero except when there is no time shift. Thus these four codes have a Interference Free Window of [−1, +1].

Similarly the following LS codes of length 16 have a Interference Free Window of [−3, +3]:

(C1, S1)=(++−++++−, +−−−+−++)

(C2, S2)=(++−+−−−+, +−−−−+−−)

(C3, S3)=(+++−++−+, +−+++−−−)

(C4, S4)=(+++−−−+−, +−++−+++)

If we consider only (C1,S1) and (C2,S2), they have a Interference Free Window of [−7,+7].

Thus, when remote units transmit to a base station signals that are modulated using a set of LS codes that have a Interference Free Window of [−n, +n], these signals will not interfere with each other as long as they arrive at the receiving base station within n chips with respect to each other. This eliminates inter-symbol interferences and multiple access interferences when multipath signals from the same remote unit and signals from different remote units arrive within an Interference Free Window.

The selected orthogonal spread spectrum codes can be LS codes. And such a framing method, frame, or system will be referred to as LAS-CDMA.

In the preferred embodiment of LAS-CDMA, ISI and MAI can be reduced to zero for all signals within a zero-correlation window, (i.e., a time window within which there is zero-correlation), while ACI can be reduced to a marginal level. As long as multipath signals from a same remote unit and signals from multiple remote units are synchronized within a zero-correlation window, the ISI and MAI can be reduced to zero. Thus, using LAS-CDMA technology, high system performance and capacity can be ideally achieved.

Preferably, the LS codes fill the said time slot in form of an LS frame, which has a certain length and further includes a C component for C code and an S component for S code, while the C code and the S code of the LS code are filled in the said C component and S component separately.

Preferably, when the length of the said allocated LS codes is shorter than length of the C component plus the S component, multiple LS codes can be used to fill the C component and the S component of the LS frame.

In case that the selected orthogonal spread spectrum codes are LS codes, the number of the LS codes is determined by the required zero correlation window of the LS codes.

The frames can be a downlink frame. The downlink frame includes:

A frame head, used for providing a forward synchronous channel of base station to mobile station and transmitting the synchronous and system information sent by the base station to the mobile station;

A plurality of sub-frames, used for providing the control and traffic channel of base station to mobile station;

And wherein the said frame head is divided into a plurality of time slots, in which each time slot is filled in by modulation with spread spectrum codes; the number of the said sub-frame is determined by the periodicity of the selected LA codes; each sub-frame is formed by a plurality of time slots, the number of the said time slots is determined by the number of pulses of the said LA codes, and the said time slot length varies with the variation of the pulse interval of the said LA codes; each time slot is filled in by modulation with spread spectrum codes. And, the said plurality of time slots may possess equal lengths.

The said frames can be an uplink frame. The said uplink frame includes:

A frame head, used for providing a reverse synchronous channel for a mobile station to base station and establishing and keeping reverse synchronization between the mobile station and base station;

A plurality of sub-frames, used for providing the control and traffic channel for a mobile station to base station;

And, wherein the said frame head is divided into access time slots in order to send out the access signals modulated by orthogonal spread spectrum codes to a base station, in which the length thereof depends on the length of the access signals and the maximum time delay at the time of reverse synchronization between mobile station and base station;

the number of the sub-frame is determined by the periodicity of the selected LA codes; each sub-frame is formed by a plurality of time slots, the number of the said time slots is determined by the number of pulses of the said LA codes, and the said time slot length varies with the variation of the pulse interval of the said LA codes; each time slot is filled in by modulation with spread spectrum codes. The said plurality of time slots may possess equal lengths.

FIG. 4 illustrates the structure of a time slot (“TS0”) or a time slot within a sub-frame (“TS1, . . . , TS16”) according to a preferred embodiment of the present invention. The length of time slot TS0 is always 136 chips, and the time slots within a sub-frame (“TS1, . . . , TS16”) may vary depending upon the LA-CDMA code used in the sub-frame and are at least 137 chips. Each time slot (“TS0, TS1, . . . , TS16”) has a similar structure, with a 4-chip gap, followed by a 64-chip C code, and then a 4-chip gap, and then followed by a 64-chip S code, and then followed by a gap whose length is 0 for TS0 and can vary for a time slot within a sub-frame depending upon the LA-CDMA code used for the sub-frame.

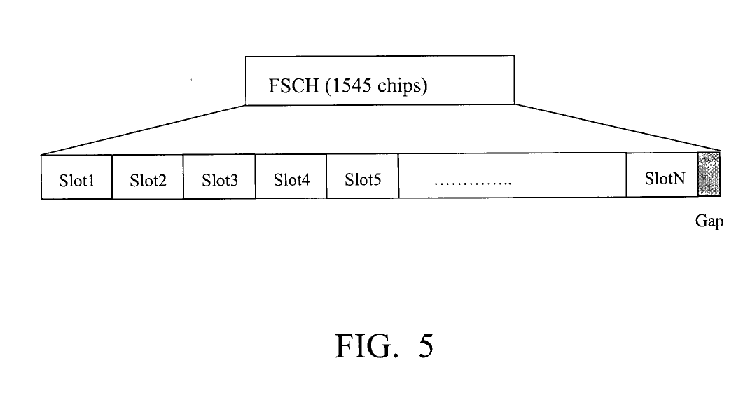

FIG. 5 illustrates the structure of the Forward Sync Channel on the downlink. It is divided into a number (“N”) of slots of equal length, followed by a gap. Each slot is spread by using a spreading code. To reduce the adjacent cell interference, different base stations in different, nearby cells should use different spreading codes for the Forward Sync Channel. For example, the Forward Sync Channel can be divided into 12 slots of 128 chips each, followed by a gap of 9 chips, and each slot can be spread by using an LS code of length 128 or some transformation of an LS code as disclosed in an PCT Application with inventor, number and title of it respectively as Li Daoben, PCT-CN98/00028, and “A Scheme for Spread Spectrum Multiple Address Coding with Interference Free Window.”

As a preferred embodiment, let the Forward Sync Channel be divided into 53 slots (N=53) with 29 chips in each slot, 4-chip gap in the front and 4-chip gap in the end.

The said orthogonal spread spectrum codes can be transformed equivalently. The spreading codes for the Forward Sync Channel can be derived using a method comprising the following steps:

1. Let A₀=(a_{0,0}, a_{0,1}. . . a_{0,L-1})=(+++++−+0+0−++−0 0+−0−−), and A₁=(a_{1,0}, a_{1,1}. . . a_{1,L-1})=(−++−0 0+ −0−−+++++−+0+0),where L=21.

2. The patent titled “An Orthogonal Transformation Method,” inventor Daoben Li, PCT Number PCT/CN00/00092, disclosed an orthogonal transformation method to derive new codes from an existing code. An orthogonal transformation of a 21-chip code is defined by

A_{i,k}=[a_{i,0},a_{i,l}e^{Jφ}^{ₖ}, . . . ,a_{i,L-1}e^{J(L-1)φ}^{ₖ}], where φₖ=2πk/L, k=0, 1, . . . L−1.

3. Extend each code A_{i,k} of length 21 chips to a code of length 29 by adding the last 4 chips of the 21-chip code to the front and adding the first 4 chips of the 21-chip code to the end.

4. Different nearby base stations are assigned different 29-chip codes for their Forward Sync Channel to reduce the adjacent cell interference.

Other embodiments of the Foreword Sync Channel are also possible by using different lengths of slots and different spreading codes in the slots, which should be covered by the present invention.

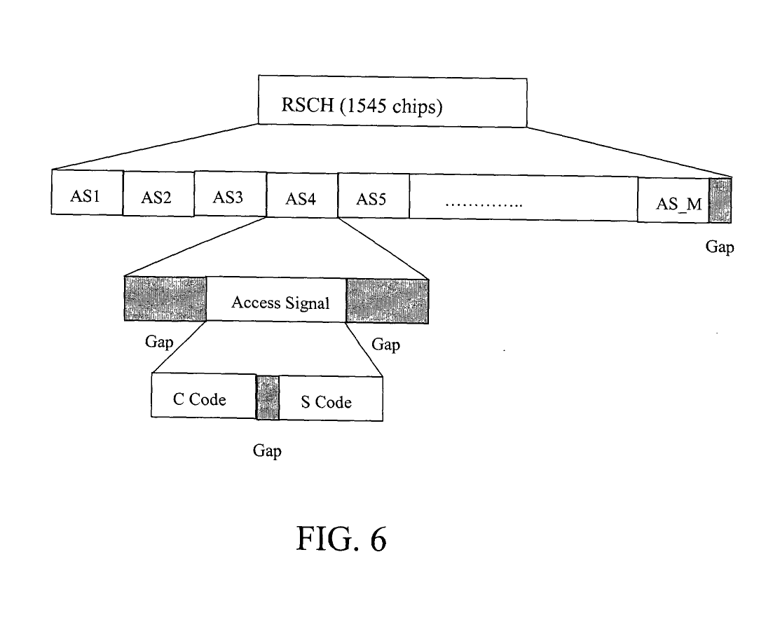

FIG. 6 illustrates the structure of the Reverse Sync Channel on the uplink. It is divided into a number (“M”) of access slots (“AS”) of equal length, followed by a gap. Each access slot is used by remote units to send access signals to a base station for reverse synchronization. As illustrated in FIG. 6, an access slot contains an access signal, with gaps on both sides of an access signal to provide room for adjusting the transmission time of an access signal in order for a remote unit to achieve reverse synchronization with a base station. An access signal can be a spread spectrum signal using an orthogonal code, such as an LS code or any transformation of an LS code. FIG. 6 illustrates a preferred embodiment of an access signal that is spread using an LS code with some gap between the C code and the S code.

The length of an access slot is determined according to the length of an access signal and the maximum delay from a remote unit to a base station when the remote unit attempts to establish reverse synchronization with the base station.

To reduce the adjacent cell interference, different, nearby base stations should use different spreading codes for access signals on the Reverse Sync Channel.

Different arrangements of the frame on the downlink and of the frame on the uplink are also possible. For example, the time slots (“TS0's”) in front of each sub-frame can be merged with the Forward Sync Channel to provide a Forward Sync Channel of length 2769 chips, or they can be re-arranged to create another sub-frame of length 2423 chips and a Forward Sync Channel of length 346 chips. Similarly, on the uplink, the time slots in front of each sub-frame can be merged with the Reverse Sync Channel to provide a Reverse Sync Channel of length 2769 chips, or they can be re-arranged to create another sub-frame of length 2423 chips and a Reverse Sync Channel of length 346 chips.

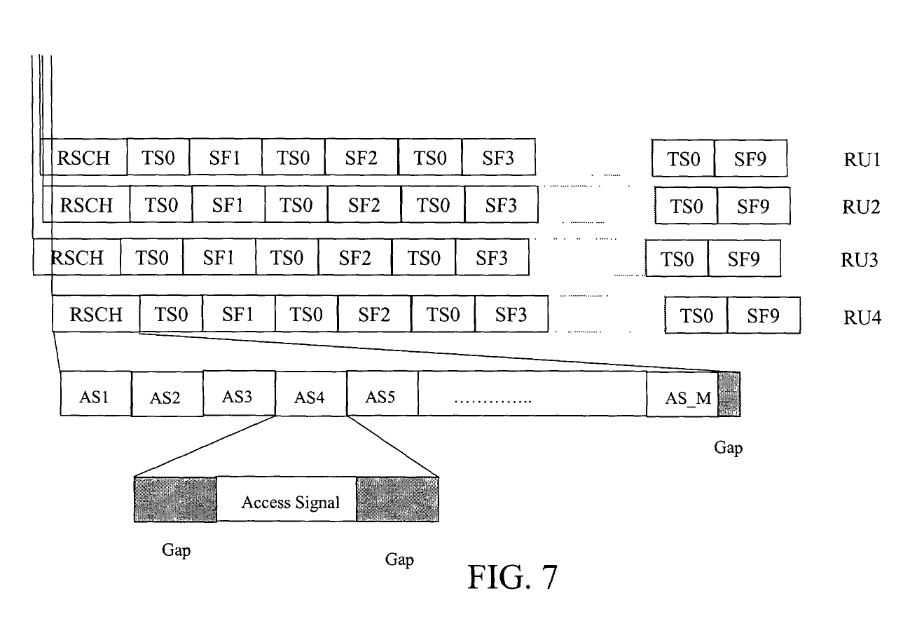

Due to the combination of time division multiple access and code division multiple access, remote units in the preferred embodiment of the system of the present invention may not transmit signals continuously. When considering the arrival time of a signal from a remote unit that transmits in only designated time slots and sub-frames, the arrival time is normalized to the beginning of the 20 ms frame on the uplink. FIG. 7 illustrates the arrival times of signals from four different remote units that are normalized to the beginning of a 20 ms frame. Remote units RU1, RU2, and RU3 are currently connected to a base station and are transmitting control and traffic signals within their allocated time slot and sub-frame using their allocated spreading codes. The transmissions from RU1 and RU3 overlap in time, but they use different spreading codes. Remote unit RU4 attempts to establish reverse synchronization by transmitting an access signal, where the access signal is always considered to be in the middle of an access slot when normalizing the arrival time of an access signal to the beginning of a 20 ms frame on the uplink.

A set of remote units are considered to be synchronized with each other with respect to a zero-correlation window [−n, +n] if the time difference between the arrival times of any two remote units in the set is no more than n chips.

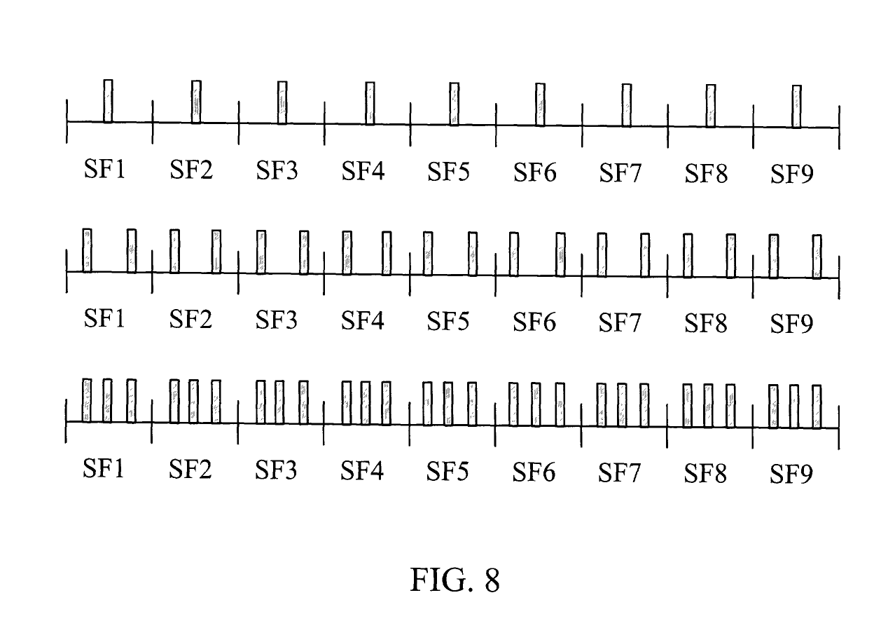

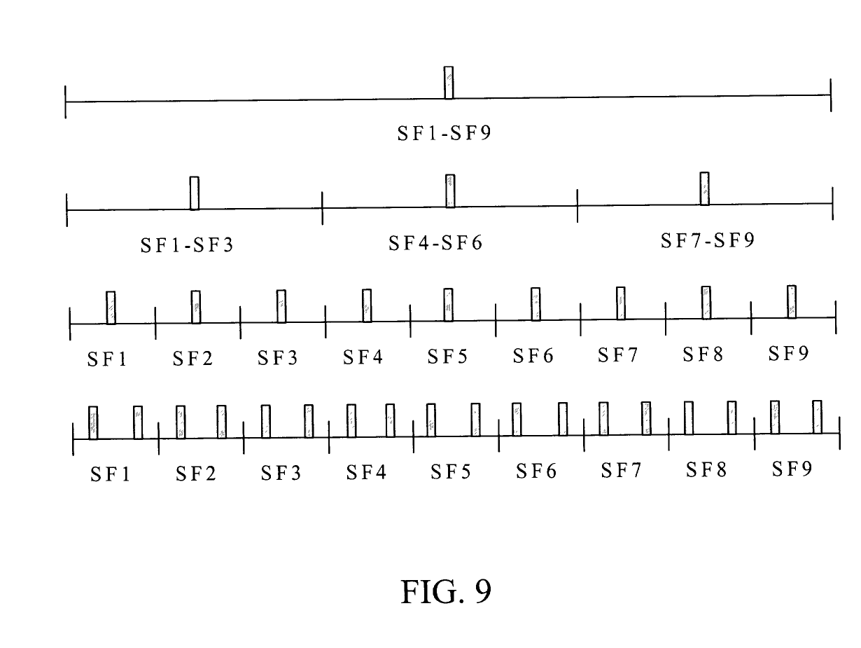

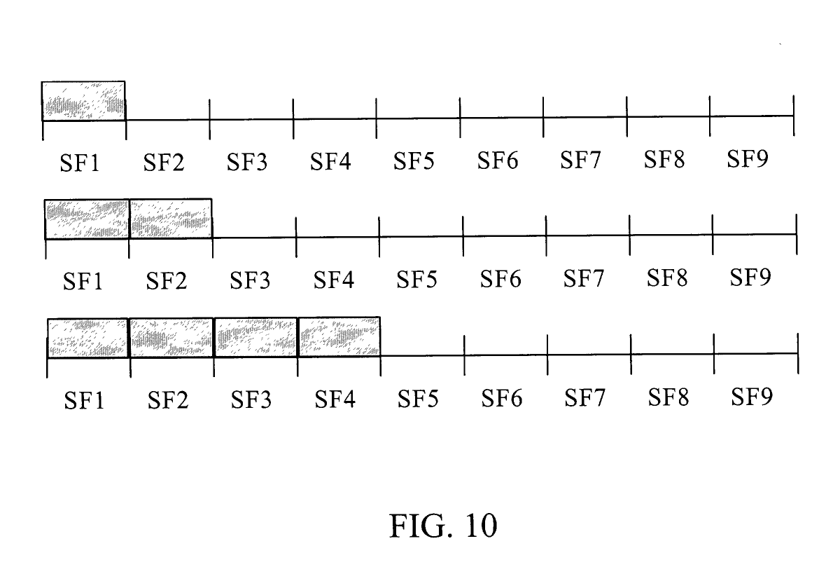

FIG. 8 and FIG. 9 illustrate the different time slot allocations per LS code for a pilot channel and a power control channel. FIG. 10 illustrates the different sub-frame allocations per LS code for a fundamental channel.

A preferred embodiment of the present invention includes a method to support speech and data communications by creating various channels, comprising the following steps:

Creating a cellular system to serve a geographic area by putting one base station in each cell;

Assigning to each base spreading codes for its Forward Sync Channel, spreading codes for its Reverse Sync Channel, and an LA-CDMA code to be used in each sub-frame on both the downlink and uplink;

Each base station transmitting a Forward Sync Channel in the designated time duration of FSCH to provide synchronization and system information to remote units;

Allocating LS codes/sub-frames to common and dedicated data channels to be transmitted by a base station, such as paging channels, forward common control channels, forward fundamental channels, forward dedicated control channels, and forward packet channels for packet data;

Allocating LS codes/time slots to common and dedicated control channels to be transmitted by a base station, such as pilot and power control channels;

A plurality of remote units accessing the base station by transmitting in slots in the Reverse Sync Channel in the designated time duration of RSCH to establish reverse synchronization with a base station;

Allocating LS codes/sub-frames to common and dedicated data channels on the uplink, such as access channels, reverse common control channels, reverse fundamental channels, reverse dedicated control channels, and reverse packet channels for data;

Allocating LS codes/time slots to common and dedicated control channels on the uplink, such as reverse pilot channel and reverse power control channel;

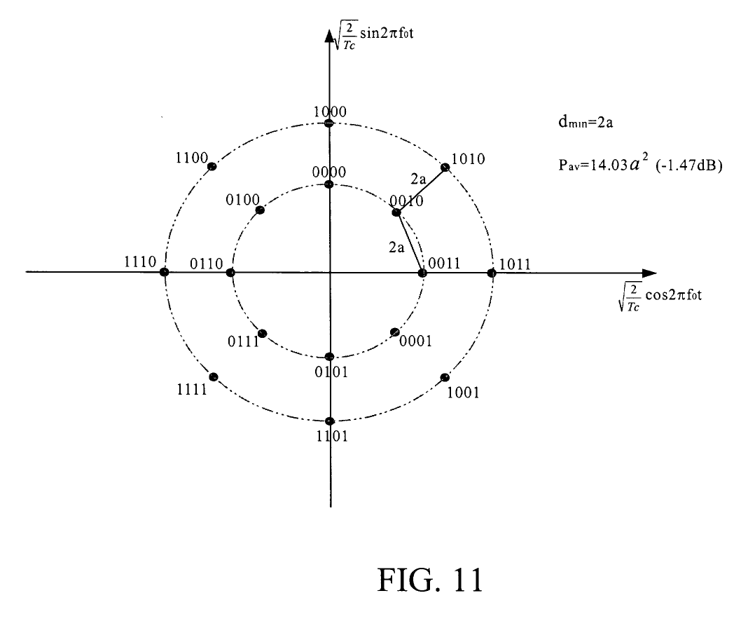

For modulation, the present invention introduces an enhanced 16QAM, whose state diagram is illustrated in FIG. 11. Other modulations such as QPSK can also be used.

It will be apparent to those skilled in the art that various modifications can be made to the present cell selection method without departing from the scope and spirit of the present invention. It is intended that the present invention covers modifications and variations of the systems and methods provided they fall within the scope of the claims and their equivalents. Further, it is intended that the present invention cover present and new applications of the system and methods of the present invention.

What is claimed:

1. A framing method for a physical layer of a wireless system, wherein the method includes the steps of:
partitioning a data stream into frames according to a frame length, in which a number of sub-frames in each frame is determined by the periodicity of selected LA codes;
forming each sub-frame from a plurality of time slots, in which the number of said time slots is determined by the number of pulses of said LA codes, and the time slot length varies with the variation of the pulse interval of the LA codes, the LA codes and their corresponding time slots having a permutation position and a polarity; and
filling in each time slot through modulation of selected orthogonal spread spectrum codes.

2. The method of claim 1, wherein the permutation position of the LA codes can be recombined, and the permutation of a corresponding time slot can also be recombined.

3. The method of claim 1, wherein the pulse polarity of the LA codes can be transformed, and the polarity of a corresponding time slot can also be transformed.

4. The method of claim 1, wherein the selected orthogonal spread spectrum codes are LS codes.

5. The method of claim 4, wherein the LS codes fill the time slot in the form of an LS frame, which has a certain length and further includes a C component for a C code and an S component for an S code, while the C code and the S code of the LS code are filled in said C component and S component separately.

6. The method of claim 5, wherein when the length of the allocated LS codes is shorter than length of the C component plus the S component, multiple LS codes can be used to fill the C component and the S component of the LS frame.

7. The method of claim 4, wherein an Interference Free Window of the LS codes determines the number of the LS codes.

8. The method of claim 1, wherein the said orthogonal spread spectrum codes can be transformed equivalently.

9. The method of claim 1, wherein at least one of said frames is a downlink frame.

10. The method of claim 9, wherein the said downlink frame includes:
a frame head, used for providing a forward synchronous channel of base station to mobile station and transmitting synchronous and system information sent by the base station to the mobile station; and
a plurality of sub-frames, used for providing the control and traffic channel for the base station to mobile station, wherein the frame head is divided into a plurality of time slots, in which each time slot is filled in by modulation with spread spectrum codes;
the number of the sub-frames is determined by the periodicity of the selected LA codes; each sub-frame is formed by a plurality of time slots, the number of the time slots is determined by the number of pulses of the said LA codes, and the said time slot length varies with the variation of the pulse interval of the said LA codes; and
each time slot is filled in by modulation with spread spectrum codes.

11. The method of claim 10, wherein the plurality of time slots possesses an equal length.

12. The method of claim 10, wherein the first time slot of each sub-frame is used for transmission of a pilot signal.

13. The method of claim 1, wherein at least one of said frames is an uplink frame.

14. A method of claim 13, wherein the said uplink frame includes:
a frame head, used for providing a reverse synchronous channel of mobile station to base station and establishing and keeping reverse synchronization between the mobile station and base station; and
a plurality of sub-frames, used for providing the control and traffic channel for the mobile station to base station, wherein the said frame head is divided into access time slots in order to send out the access signals modulated by orthogonal spread spectrum codes to the base station, in which the length thereof lies on the length of the access signals and the maximum time delay at the time of reverse synchronization between the mobile station and base station;
the number of the sub-frames is determined by the periodicity of the selected LA codes; each sub-frame is formed by a plurality of time slots, the number of the said time slots is determined by the number of pulses of the said LA codes, and the said time slot length varies with the variation of the pulse interval of the said LA codes; and
each time slot is filled in using modulation of spread spectrum codes.

15. The method of claim 14, wherein the plurality of time slots possesses an equal length.

16. The method of claim 14, wherein the first time slot of the said each sub-frame is used for transmission of a pilot signal.

17. The method of claim 1, wherein the frame length is 20 ms, and each of the said LA codes includes 17 pulse intervals.

18. The method of claim 17, wherein the minimum interval of the LA codes is 136 chips.

19. The method of claim 17, wherein the modulation with the selected orthogonal spread spectrum codes is an enhanced 16QAM modulation.

20. The method of claim 1, wherein a time slot with a certain length is put in front of each of the sub frames.

21. A synchronous wireless system, comprising:
a data stream partitioned into frames according to the frame length, wherein a number of sub-frames in each frame is determined by the periodicity of selected LA codes; and
a base station and a mobile station, wherein the base station and mobile station each use LA codes and LS codes, and different base stations use different LA codes and LS codes, wherein each sub-frame is formed by a plurality of time slots, in which the number of said time slots is determined by the number of pulses of said LA codes, and the time slot length varies with the variation of the pulse interval of the LA codes, the LA codes and their corresponding time slots having a permutation position and a polarity;
wherein each time slot is capable of being filled using modulation of selected orthogonal spread spectrum codes; and
wherein different subscribers are distinguished by means of a CDMA and TDMA mode according to the frames' structure.

22. The system of claim 21, wherein different LS orthogonal spread spectrum codes are adopted in the CDMA mode, while different sub-frames are introduced in the TDMA mode.
